(19) United States
(12) Patent Application Publication
(10) Pub. No.: US 2025/0184988 A1
(43) Pub. Date: Jun. 5, 2025

(54) SIDELINK INTERFERENCE REDUCTION

(71) Applicant: QUALCOMM Incorporated, San Diego, CA (US)

(72) Inventors: Hui GUO, Beijing (CN); Tien Viet NGUYEN, Bridgewater, NJ (US); Shuanshuan WU, San Diego, CA (US); Sourjya DUTTA, San Diego, CA (US); Kapil GULATI, Belle Mead, NJ (US); Gabi SARKIS, San Diego, CA (US)

(21) Appl. No.: 18/833,653

(22) PCT Filed: Mar. 31, 2022
(86) PCT No.: PCT/CN2022/084433

§ 371 Date: Jul. 26, 2024

(51) Int. Cl. H04W 72/11; H04W 72/40; H04W 72/566

(52) U.S. Cl. CPC H04W 72/11; H04W 72/40; H04W 72/566

(57) ABSTRACT

Various aspects of the present disclosure generally relate to wireless communication. In some aspects, a user equipment (UE) may reserve, during a first semi-persistent scheduling (SPS) period of a plurality of SPS periods, a plurality of resources in the plurality of SPS periods. The UE may skip a first resource of the plurality of resources in a second SPS period of the plurality of SPS periods. The UE may perform an initial transmission in the second SPS period using a second resource of the plurality of resources in the second SPS period. Numerous other aspects are provided.

### FIELD OF THE DISCLOSURE

Aspects of the present disclosure generally relate to wireless communication and specifically, to techniques and apparatuses for sidelink interference reduction.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In some cases, a user equipment (UE) using semi-persistent scheduling (SPS) communications may reserve the same resource(s) in a plurality of SPS periods. For example, a first transmission that occurs in a first resource of a first SPS period may reserve and signal a second resource and a third resource in the first SPS period. The second resource and the third resource may be used for retransmission of the same transport block. Similarly, the first transmission in the first SPS period may reserve and signal a first resource, a second resource, and a third resource in a second SPS period. The first resource, second resource, and third resource in the second SPS period may occur the same location (e.g., the same sub-channel in a slot) as the first resource, second resource, and third resource in the first SPS period, respectively. In some cases, the first transmission in each of the SPS periods may be more likely to conflict (overlap) with transmissions or reservations by another UE. For example, the other UE may be able to detect (using sensing or sidelink control information (SCI) decoding) the transmissions or reservations in the second resource or the third resource. However, the other UE may not be able to detect the transmission or reservation in the first resource prior to performing a transmission or reservation in that resource. In some cases, the overlapping transmissions or reservations may disrupt communications and may result in an increased quantity of missed communications and an increased quantity of packet retransmissions.

### SUMMARY

Some aspects described herein relate to a method of wireless communication performed by a user equipment (UE). The method may include reserving, during a first semi-persistent scheduling (SPS) period of a plurality of SPS periods, a plurality of resources in the plurality of SPS periods. The method may include skipping a first resource of the plurality of resources in a second SPS period of the plurality of SPS periods. The method may include performing an initial transmission in the second SPS period using a second resource of the plurality of resources in the second SPS period.

Some aspects described herein relate to an apparatus for wireless communication performed by a UE. The apparatus may include a memory and one or more processors, coupled to the memory. The one or more processors may be configured to reserve, during a first SPS period of a plurality of SPS periods, a plurality of resources in the plurality of SPS periods. The one or more processors may be configured to skip a first resource of the plurality of resources in a second SPS period of the plurality of SPS periods. The one or more processors may be configured to perform an initial transmission in the second SPS period using a second resource of the plurality of resources in the second SPS period.

Some aspects described herein relate to a non-transitory computer-readable medium that stores a set of instructions for wireless communication by a UE. The set of instructions, when executed by one or more processors of the UE, may cause the UE to reserve, during a first SPS period of a plurality of SPS periods, a plurality of resources in the plurality of SPS periods. The set of instructions, when executed by one or more processors of the UE, may cause the UE to skip a first resource of the plurality of resources in a second SPS period of the plurality of SPS periods. The set of instructions, when executed by one or more processors of the UE, may cause the UE to perform an initial transmission in the second SPS period using a second resource of the plurality of resources in the second SPS period.

Some aspects described herein relate to an apparatus for wireless communication. The apparatus may include means for reserving, during a first SPS period of a plurality of SPS periods, a plurality of resources in the plurality of SPS periods. The apparatus may include means for skipping a first resource of the plurality of resources in a second SPS period of the plurality of SPS periods. The apparatus may include means for performing an initial transmission in the second SPS period using a second resource of the plurality of resources in the second SPS period.

Aspects generally include a method, apparatus, system, computer program product, non-transitory computer-readable medium, user equipment, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station in communication with a user equipment (UE) in a wireless network in accordance with the present disclosure.

FIG. 3 is a diagram illustrating an example of sidelink communications in accordance with the present disclosure.

FIG. 4 is a diagram illustrating an example of sidelink communications and access link communications in accordance with the present disclosure.

FIG. 5 is a diagram illustrating an example of sidelink resource reservation in accordance with the present disclosure.

FIG. 6 is a diagram illustrating an example of sidelink sensing and resource selection in accordance with the present disclosure.

FIG. 7 is a diagram illustrating an example associated with sidelink interference reduction in accordance with the present disclosure.

FIG. 8 is a diagram illustrating an example associated with resource skipping in accordance with the present disclosure.

FIG. 9 is a diagram illustrating an example associated with additional resource reservation in accordance with the present disclosure.

FIG. 10 is a flowchart illustrating an example process performed, for example, by a UE in accordance with the present disclosure.

FIG. 11 is a diagram of an example apparatus for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to sidelink interference reduction. Some aspects more specifically relate to sidelink semi-persistent scheduling (SPS) resource skipping. In some aspects, a user equipment (UE) may reserve a plurality of resources in a plurality of SPS periods. For example, the UE may reserve the plurality of resources during a first SPS period of the plurality of SPS periods. In some aspects, in a second SPS period of the plurality of SPS periods, the UE may skip a first resource of the plurality of resources and may perform an initial transmission in the second SPS period using a second resource of the second SPS period. In some aspects, the UE may skip the first resource in each of the plurality of SPS periods. In some aspects, the UE may skip the first resource in the second SPS period, but may perform an initial transmission in a third SPS period using a first resource of the third SPS period. In some aspects, the resource skipping may be performed based at least in part on a condition, such as a packet priority or a resource collision detection.

Particular aspects of the subject matter described in this disclosure can be implemented to realize one or more of the following potential advantages. In some examples, the described techniques can be used to reduce a likelihood of a resource collision, thereby resulting in fewer missed communications and fewer packet retransmissions.

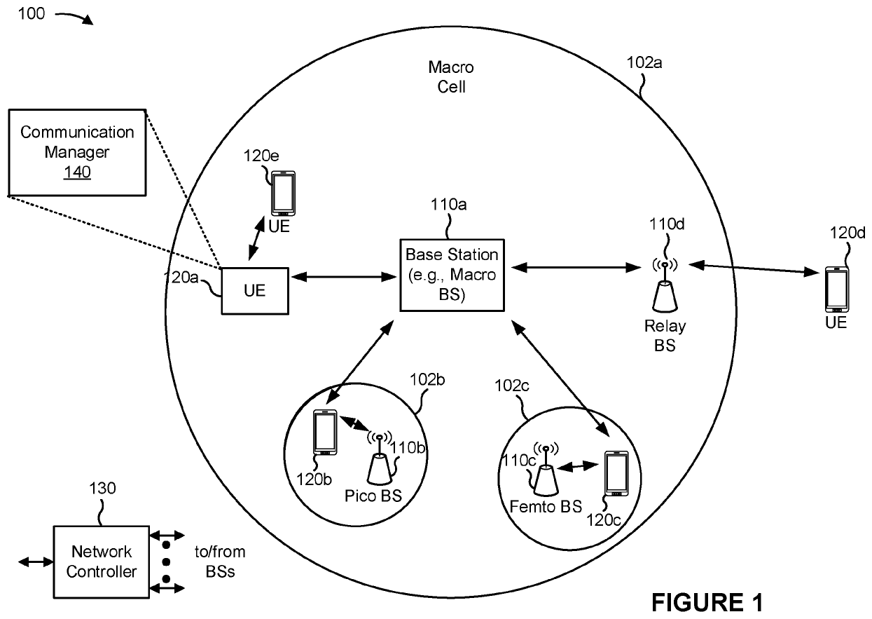

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (for example, in 4G), a gNB (for example, in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, for example, base station 110), or one or more units (or one or more components) performing base station functionality, may be implemented in an aggregated or disaggregated architecture. For example, a BS (such as a Node B (NB), eNB, NR BS, 5G NB, access point (AP), a TRP, or a cell) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some examples, a cell may not necessarily be stationary, and the geographic area of the cell may move in accordance with the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz,” if used herein, may broadly represent frequencies that may be less than 6 GHZ, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may reserve, during a first SPS period of a plurality of SPS periods, a plurality of resources in the plurality of SPS periods; skip a first resource of the plurality of resources in a second SPS period of the plurality of SPS periods; and perform an initial transmission in the second SPS period using a second resource of the plurality of resources in the second SPS period. Additionally or alternatively, the communication manager 140 may perform one or more other operations described herein.

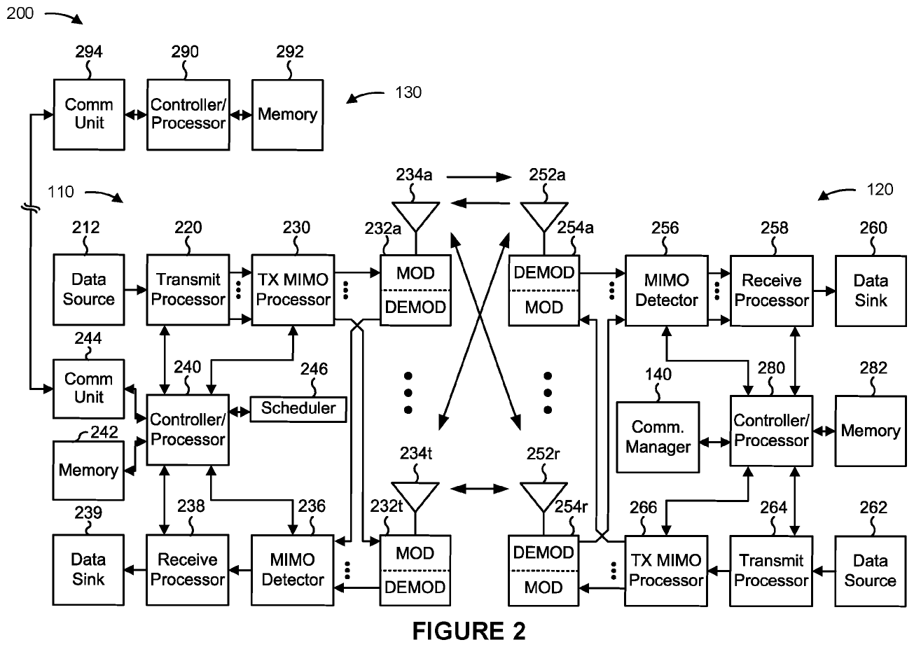

FIG. 2 is a diagram illustrating an example base station in communication with a UE in a wireless network in accordance with the present disclosure. The base station may correspond to the base station 110 of FIG. 1. Similarly, the UE may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

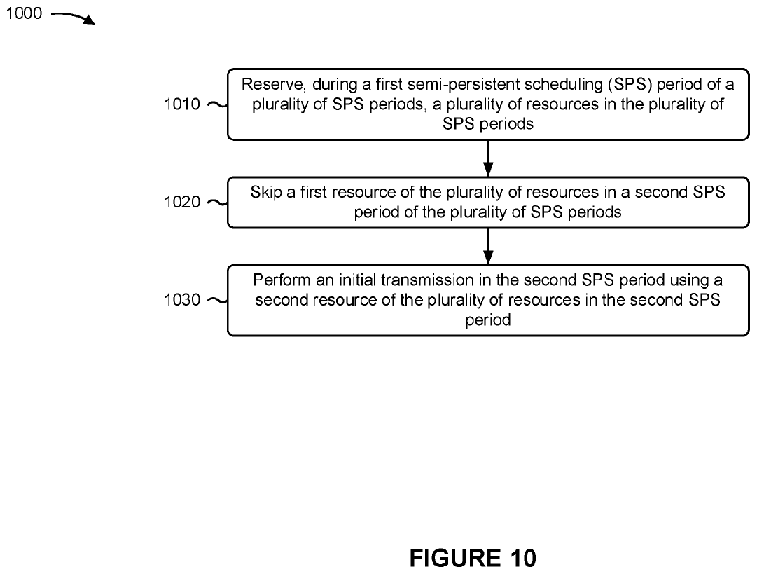

The controller/processor 240 of the base station 110, the controller/processor 280 of the UE 120, or any other component(s) of FIG. 2 may perform one or more techniques associated with sidelink interference reduction, as described in more detail elsewhere herein. For example, the controller/processor 240 of the base station 110, the controller/processor 280 of the UE 120, or any other component(s) of FIG. 2 may perform or direct operations of, for example, process 1000 of FIG. 10, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 1000 of FIG. 10, or other processes as described herein. In some examples, executing instructions may include running the instructions, converting the instructions, compiling the instructions, or interpreting the instructions, among other examples.

In some aspects, the UE includes means for reserving, during a first SPS period of a plurality of SPS periods, a plurality of resources in the plurality of SPS periods; means for skipping a first resource of the plurality of resources in a second SPS period of the plurality of SPS periods; or means for performing an initial transmission in the second SPS period using a second resource of the plurality of resources in the second SPS period. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

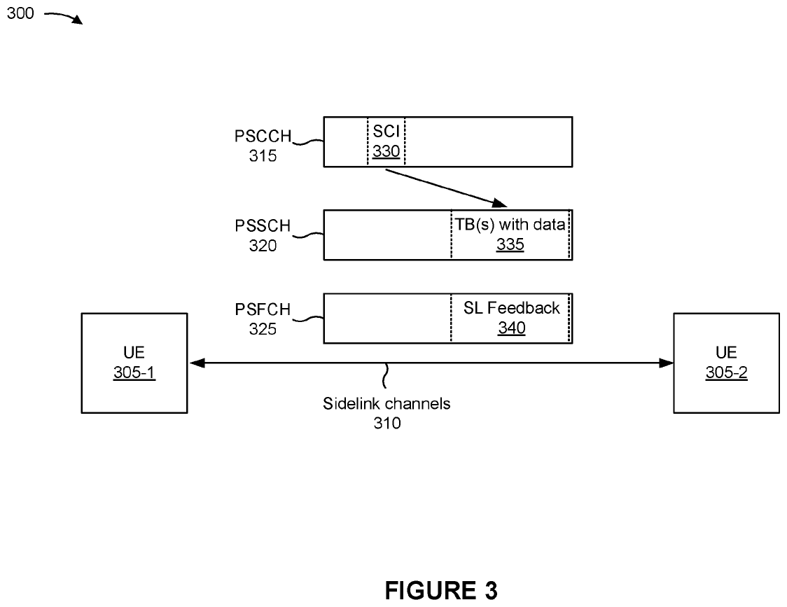

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (which may include V2V communications, V2I communications, or V2P communications) or mesh networking. In some aspects, the UEs 305 (for example, UE 305-1 or UE 305-2) may correspond to one or more other UEs described elsewhere herein, such as UE 120. In some aspects, the one or more sidelink channels 310 may use a PC5 interface or may operate in a high frequency band (for example, the 5.9 GHz band). Additionally or alternatively, the UEs 305 may synchronize timing of transmission time intervals (TTIs) (for example, frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, or a physical sidelink feedback channel (PSFCH) 325. The PSCCH 315 may be used to communicate control information, similar to a physical downlink control channel (PDCCH) or a physical uplink control channel (PUCCH) used for cellular communications with a base station 110 via an access link or an access channel. The PSSCH 320 may be used to communicate data, similar to a physical downlink shared channel (PDSCH) or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (for example, time resources, frequency resources, or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (for example, acknowledgement or negative acknowledgement (ACK/NACK) information), transmit power control (TPC), or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (for example, time resources, frequency resources, or spatial resources) on the PSSCH 320, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, or an MCS. The SCI-2 may include information associated with data transmissions on the PSSCH 320, such as a HARQ process ID, a new data indicator (NDI), a source identifier, a destination identifier, or a channel state information (CSI) report trigger.

In some aspects, the one or more sidelink channels 310 may use resource pools. For example, a scheduling assignment (included in SCI 330) may be transmitted in sub-channels using specific resource blocks (RBs) across time. In some aspects, data transmissions (for example, on the PSSCH 320) associated with a scheduling assignment may occupy adjacent RBs in the same subframe as the scheduling assignment (for example, using frequency division multiplexing). In some aspects, a scheduling assignment and associated data transmissions are not transmitted on adjacent RBs.

In some aspects, a UE 305 may operate using a sidelink transmission mode (Mode 1) where resource selection or scheduling is performed by a base station 110. For example, the UE 305 may receive a grant (for example, in downlink control information (DCI) or in a radio resource control (RRC) message, such as for configured grants) from the base station 110 for sidelink channel access or scheduling. In some aspects, a UF 305 may operate using a transmission mode (Mode 2) where resource selection or scheduling is performed by the UE 305 (rather than a base station 110). In some aspects, the UE 305 may perform resource selection or scheduling by sensing channel availability for transmissions. For example, the UE 305 may measure an RSSI parameter (for example, a sidelink-RSSI (S-RSSI) parameter) associated with various sidelink channels, may measure an RSRP parameter (for example, a PSSCH-RSRP parameter) associated with various sidelink channels, or may measure an RSRQ parameter (for example, a PSSCH-RSRQ parameter) associated with various sidelink channels, and may select a channel for transmission of a sidelink communication based at least in part on the measurement(s).

Additionally or alternatively, the UE 305 may perform resource selection or scheduling using SCI 330 received in the PSCCH 315, which may indicate occupied resources or channel parameters. Additionally or alternatively, the UE 305 may perform resource selection or scheduling by determining a channel busy ratio (CBR) associated with various sidelink channels, which may be used for rate control (for example, by indicating a maximum number of resource blocks that the UE 305 can use for a particular set of subframes).

In the transmission mode where resource selection or scheduling is performed by a UE 305, the UE 305 may generate sidelink grants, and may transmit the grants in SCI 330. A sidelink grant may indicate, for example, one or more parameters (for example, transmission parameters) to be used for an upcoming sidelink transmission, such as one or more resource blocks to be used for the upcoming sidelink transmission on the PSSCH 320 (for example, for TBs 335), one or more subframes to be used for the upcoming sidelink transmission, or an MCS to be used for the upcoming sidelink transmission. In some aspects, a UE 305 may generate a sidelink grant that indicates one or more parameters for SPS, such as a periodicity of a sidelink transmission. Additionally or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

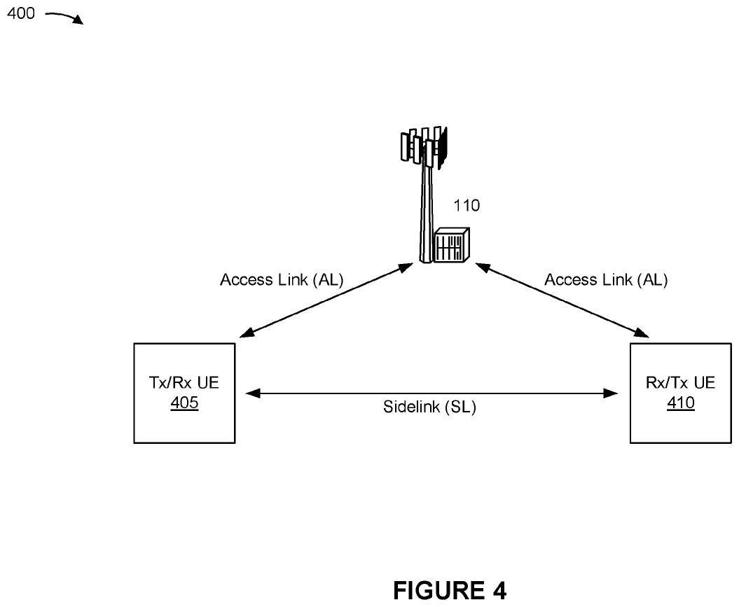

FIG. 4 is a diagram illustrating an example 400 of sidelink communications and access link communications, in accordance with the present disclosure.

As shown in FIG. 4, a transmitter/receiver (Tx/Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally or alternatively, in some sidelink modes, the base station 110 may communicate with the Rx/Tx UE 410 via a second access link. The Tx/Rx UE 405 or the Rx/Tx UE 410 may correspond to one or more UEs described elsewhere herein, such as the UE 120 of FIG. 1. Thus, a direct link between UEs 120 (for example, via a PC5 interface) may be referred to as a sidelink, and a direct link between a base station 110 and a UE 120 (for example, via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

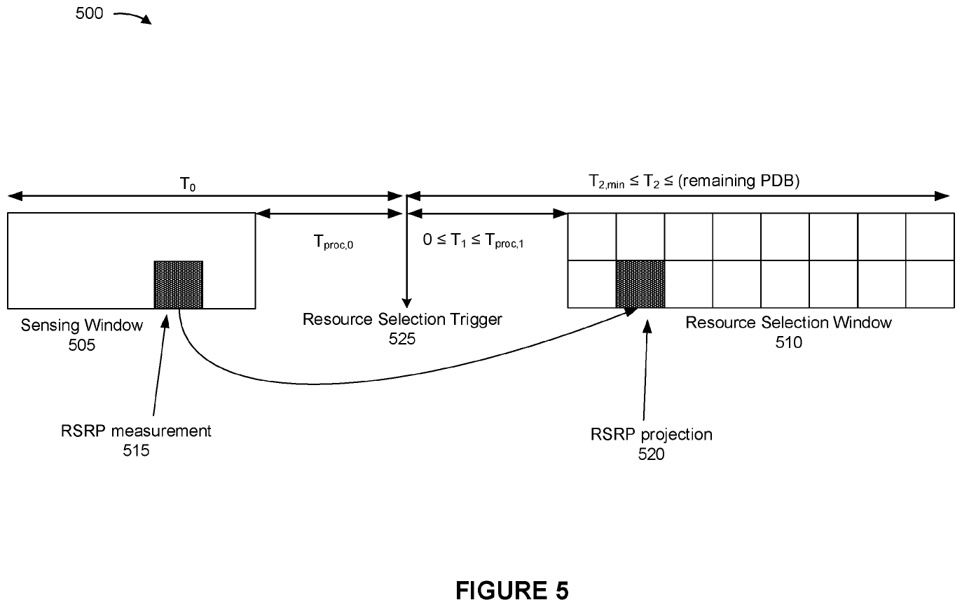

FIG. 5 is a diagram illustrating an example 500 of sidelink resource reservation, in accordance with the present disclosure.

In some cases, the UE 120 may use a sensing procedure to select one or more resources for the sidelink communications. For example, the UE 120 may perform the sensing procedure within a sensing window. The UE 120 may use the sensing procedure for aperiodic or periodic resource reservation.

The UE 120 performing the sensing procedure may decode control messages (for example, SCI) relating to resource reservations of another UE and may perform measurements (for example, RSRP measurements) associated with one or more sidelink channels. For example, the other UE may transmit reservation information (for example, via SCI) that indicates a resource reservation for a current slot (for example, the slot in which the reservation information is transmitted) and for one or more future slots. A resource allocation associated with the resource reservation may be one or more sub-channels in a frequency domain and one slot in a time domain.

In some cases, a sidelink resource may be considered available if the sidelink resource has a signal energy (for example, RSRP) that satisfies an availability threshold (for example, if the measured interference or energy on the channel is lower than a maximum decibel-milliwatts (dBm) or dB, RSRP threshold). The availability threshold may be configured per transmission priority and receive priority pair. For example, the sensing procedure may provide an indication of resources in the resource selection window that are occupied or resources in the resource selection window that are associated with high interference.

In some cases, the UE 120 may have already sensed previous sidelink resources and successfully decoded SCI from the other UE. The UE 120 may try to reserve sidelink resources, and thus may check the availability of the future sidelink resources reserved by the other UE by sensing the sidelink channel in the sensing window. If an observed RSRP satisfies the RSRP threshold (for example, is lower than a maximum RSRP), the corresponding sidelink resource may be available for reservations by the UE 120. In some cases, the UE 120 may reserve the sidelink resource (which may be a random selection from available resources).

As shown in the example 500, the UE 120 may perform the sensing within the sensing window 505 and may perform the resource selection within the resource selection window 510. In some cases, the size (duration) of the sensing window 505 may be configured in the UE 120. For example, the sensing window size may be indicated by T₀. In some cases, the UE 120 may project the RSRP measurement 515 from the sensing window 505 to the resource selection window 510 (as shown by the RSRP projection 520). In some cases, the UE 120 may compare the RSRP measurement 515 with a threshold, and may increase the threshold until a percentage (for example, a configurable percentage) of the resources in the resource selection window 510 have an RSRP value that is below the threshold.

In some cases, if the resource selection trigger 525 occurs in the subframe n, the resource selection window 505 may be from n+T₁ to n+T₂. In this case, T₁ may be less than a processing time (T_{proc,1}). T₂ may be greater than or equal to T_{2,min}, which may be a value configured for the UE 120 based at least in part on a priority of the UE 120 and a subcarrier spacing (SCS) configured for communication, and may be less than or equal to a remaining packet delay budget (PDB) of the UE 120.

As indicated above, FIG. 5 is provided as an example. Other examples may differ from what is described with respect to FIG. 5.

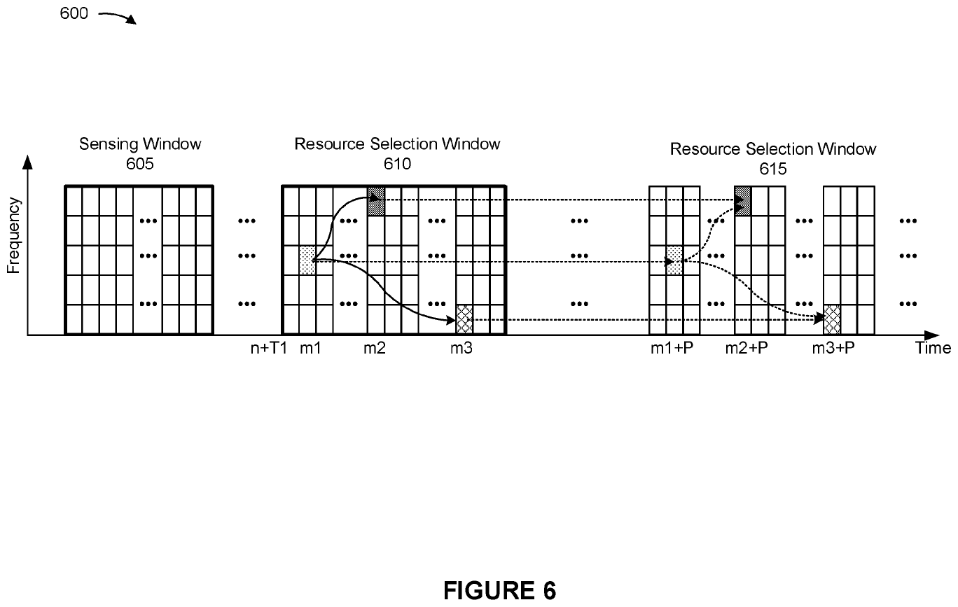

FIG. 6 is a diagram illustrating an example 600 of sidelink sensing and resource selection, in accordance with the present disclosure.

In some cases, the UE 120 may be configured to select (for example, autonomously select) one or more sidelink resources (for example, one or more sub-channels) from a resource pool when using the Mode 2 communications. In some cases, the Mode 2 communications may be SPS communications. SPS communications may include periodic communications that are configured for the UE 120. SPS communications may reduce signaling overhead by eliminating the need for a network node (for example, the base station 110) to send separate DCI to schedule each downlink transmission. In the case of sidelink communications, the SPS may eliminate the need for another UE 120 to send separate SCI to schedule each sidelink transmission. In some cases, the Mode 2 communications may be dynamic communications. In this case, DCI or SCI may be needed to schedule each downlink or sidelink transmission, respectively.

In some cases, a resource reservation interval for SPS transmissions may be indicated in the SCI, such as in SCI-1. Other UEs (for example, nearby UEs) may be aware of the resources that are reserved for a TB or consecutive resource counter TBs by decoding the SCI. In some cases, the UE 120 may trigger an SPS resource re-selection if the resource counter decreases to zero and a randomly generated re-selection probability is I-P. In other cases, the UE 120 may trigger the SPS resource re-selection if the reserved resource cannot handle a new TB traffic volume or cannot meet the latency requirement for the new TB.

In some cases, the UE 120 using the SPS reservation may reserve N resources for the initial transmission and one or more retransmissions of the TB. Additionally or alternatively, the SPS reservation may indicate the period or reservation interval in the SCI so that the same N resources are reserved (for example, in P milliseconds (ms)). In some cases, the UE 120 may perform the resource sensing in the sensing window 605 and may perform the resource selection in the resource selection window 610 or the resource selection window 615. As shown in the example 600, the UE 120 may perform a first transmission in the slot m1. Based at least in part on the first transmission in the slot m1, the UE 120 may reserve one or more other resources in slots m2 and m3. In accordance with the SPS reservation, the UE 120 may reserve one or more additional resources in the resource selection window 615. For example, the UE 120 may reserve one or more resources in slots m1+P, m2+P, or m3+P of the resource selection window 615.

In some cases, the UE 120 using the SPS reservation may reserve the same resources in a plurality of SPS periods. For example, a first transmission that occurs in a first resource of a first SPS period may reserve and signal a second resource and a third resource in the first SPS period. Similarly, the first transmission in the first SPS period may reserve and signal a first resource, a second resource, and a third resource in the second SPS period. The first resource, second resource, and third resource in the second SPS period may occur in the same location (in the second SPS period) as the first resource, second resource, and third resource in the first SPS period. For example, the first resource, second resource, and third resource of the first SPS period may occur at slots m1, m2, and m3 of the first SPS period. Similarly, the first resource, second resource, and third resource of the second SPS period may occur at slots m1+P, m2+P, or m3+P of the second SPS period. In some cases, the first transmission in each of the SPS periods may be more likely to conflict (overlap) with transmissions or reservations by another UE. For example, the other UE may be able to detect (using sensing or SCI decoding) the transmissions or reservations in the second resource or the third resource. However, the other UE may not be able to detect the transmission or reservation in the first resource prior to performing a transmission or reservation in that resource. In some cases, the overlapping transmissions or reservations may disrupt communications and may result in an increased quantity of missed communications and an increased quantity of packet retransmissions.

Various aspects relate generally to sidelink interference reduction. In some aspects, the UE 120 may reserve a plurality of resources in a plurality of SPS periods. For example, the UE 120 may reserve, during a first SPS period of the plurality of SPS periods, a first resource, a second resource, and a third resource for the plurality of SPS periods. In a second SPS period of the plurality of SPS periods, the UE 120 may skip a first resource of the plurality of resources and may perform an initial transmission in the second SPS period using a second resource of the plurality of resources. In some aspects, the UE 120 may skip the first resource in each of the plurality of SPS periods. In some aspects, the UE 120 may skip the first resource in the second SPS period but may perform an initial transmission in a third SPS period using a first resource of the third SPS period. In some aspects, the resource skipping may be performed based at least in part on a condition, such as a packet priority or a resource collision detection.

Particular aspects of the subject matter described in this disclosure can be implemented to realize one or more of the following potential advantages. In some examples, the described techniques can be used to reduce a likelihood of a resource collision, thereby resulting in fewer missed communications and fewer packet retransmissions.

As indicated above, FIG. 6 is provided as an example. Other examples may differ from what is described with respect to FIG. 6.

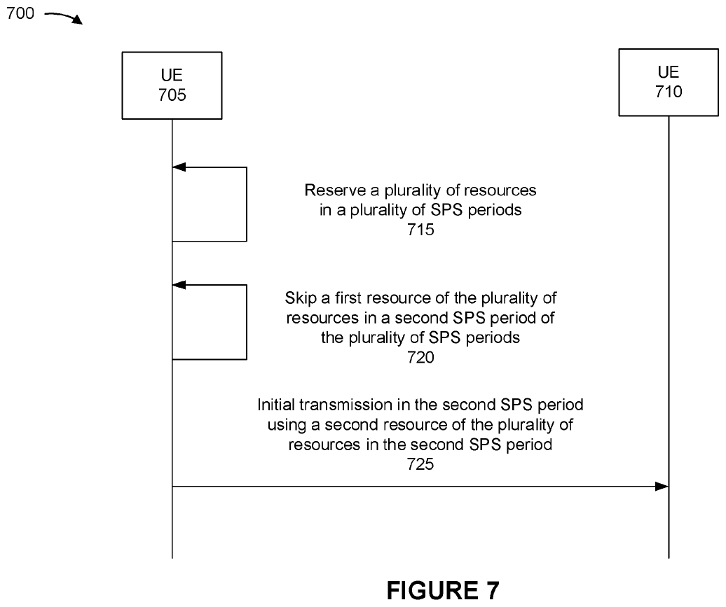

FIG. 7 is a diagram illustrating an example 700 of sidelink interference reduction, in accordance with the present disclosure. A UE 705 may communicate with a UE 710. For example, the UE 705 may communicate with the UE 710 using one or more sidelink communications. The UE 705 or the UE 710 may include some or all of the features of the UE 120, the UE 305, the UE 405, or the UE 410 described herein.

In some aspects, in a first operation 715, the UE 705 may reserve a plurality of resources in a plurality of SPS periods. As described above, an SPS communication scheme may include a plurality of SPS periods that are separated by an interval. The UE 705 may be configured to perform one or more transmissions, such as a packet transmission, a packet retransmission, or HARQ feedback, in the plurality of SPS periods. For example, the UE 705 may transmit the packet in each of the SPS periods until the packet is successfully received by another UE (such as the UE 710).

In some aspects, the UE 705 may reserve, during a first SPS period of the plurality of SPS periods, a plurality of resources in the plurality of SPS periods. For example, the UE 705 may perform a first transmission using a first resource of the first SPS period. The first transmission may include a packet. Additionally or alternatively, the first transmission may reserve one or more other resources in the first SPS period, such as a second resource and a third resource of the first SPS period. The second resource and the third resource of the first SPS period may be reserved for packet retransmission or HARQ feedback. In some aspects, the first transmission may reserve one or more resources in one or more of the other SPS periods. For example, the first transmission in the first SPS period may reserve a first resource, a second resource, and a third resource in a second SPS period. The first resource, second resource, and third resource of the second SPS period may be reserved for packet retransmission or HARQ feedback. As described herein, the location of the first resource, second resource, and third resource in the second SPS period (and other SPS periods) may correspond to the location of the first resource, second resource, and third resource in the first SPS period.

In some aspects, the UE 705 may select one or more other resources in the second SPS period or subsequent SPS periods based at least in part on resource skipping being enabled (as described below).

In some aspects, in a second operation 720, the UE 705 may skip a first resource of the plurality of resources in the second SPS period. For example, the UE 705 may skip the first resource of the second SPS period using resource skipping.

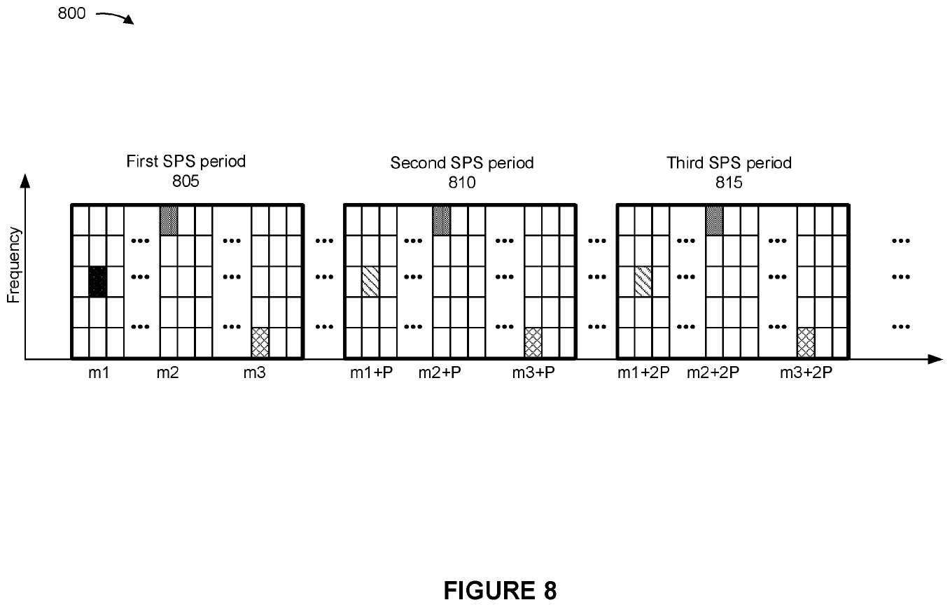

In some aspects, the resource skipping may be unconditional. For example, the UE 705 may always skip the first resource of the plurality of resources in the second SPS period. In some aspects, the first resource may be skipped for all of the SPS periods after the first SPS period. For example, the first resource may be skipped for the second SPS period and all subsequent SPS periods to avoid a conflicting SPS reservation by another UE. In some other aspects, the first resource may be skipped only for the SPS period immediately following the first SPS period. For example, the first resource may be skipped in the second SPS period, but not in the third SPS period or any subsequent SPS periods, to avoid a conflicting aperiodic reservation in the second SPS period. Additional details regarding these features are described below in connection with FIG. 8.

In some other aspects, the resource skipping may be conditional. For example, the first resource may be skipped based at least in part on an occurrence or satisfaction of a condition. In some aspects, the condition may be a packet priority, or may include a packet priority. For example, the UE 705 may skip transmitting a packet using the first resource (for example, of the second SPS period) based at least in part on the packet priority being greater than, or greater than or equal to, a packet priority threshold. Alternatively, the UE 705 may transmit the packet using the first resource based at least in part on the packet priority being less than, or less than or equal to, the packet priority threshold. In some other aspects, the condition may be a resource collision, or may include a resource collision. For example, the UE 705 may skip transmitting the packet using the first resource based at least in part on detecting the resource collision. Alternatively, the UE 705 may transmit the packet using the first resource based at least in part on not detecting the resource collision. In some aspects, detecting the resource collision may include receiving an indication of the resource collision from another UE. In some other aspects, detecting the resource collision may include detecting a quantity of consecutive decoding failures among TBs on the same resource.

In some aspects, when the resource skipping is enabled, the UE 705 may reserve one or more additional resources in one or more of the plurality of SPS periods. For example, the UE 705 may reserve one or more additional resources in the plurality of SPS periods after the first SPS period. Thus, the one or more additional resources may be reserved in the second SPS period, or in the second SPS period and all subsequent SPS periods, in accordance with the SPS configuration. The additional resources may be reserved to further avoid resource collision.

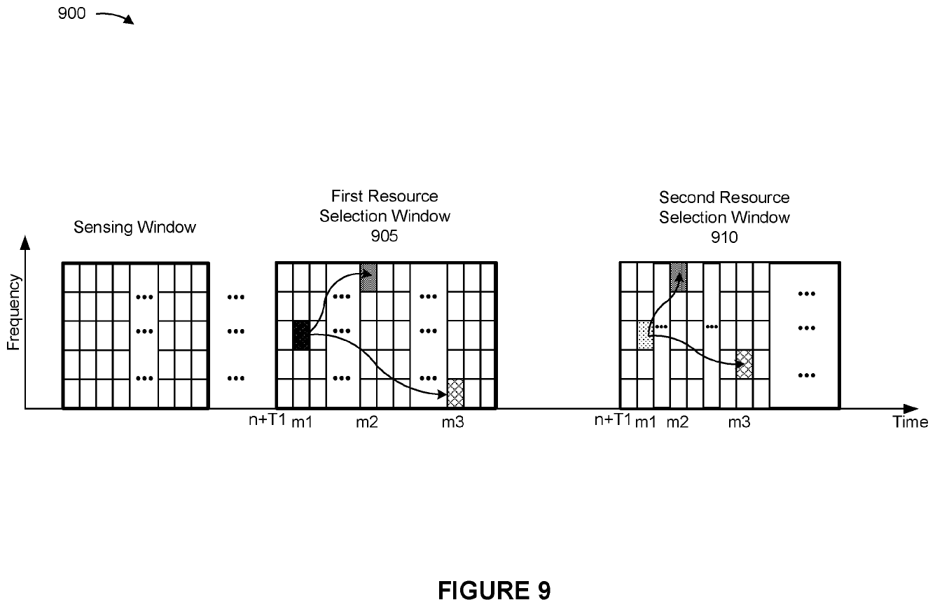

In some aspects, when the resource skipping is enabled, the UE 705 may reserve one or more resources, such as the plurality of resources or the one or more additional resources, in an early stage of a resource selection window. In some aspects, reserving the one or more resources in the early stage of the resource selection window may reduce packet latency (for example, transmission or reception latency). Additional details regarding these features are described in connection with FIG. 9.

In some aspects, when the resource skipping is enabled, the UE 705 may select a quantity of candidate resources within the same resource selection window for the initial transmission of the TB and associated (potential) HARQ retransmissions. For example, the UE 705 may select N candidate resources (N≤N_{MAX} with 1≤N_{MAX}≤32) within the resource selection window for the initial transmission of the TB and the N−1 potential HARQ retransmissions. In some aspects, N may indicate a constant retransmission quantity for all TBs within the SPS random counter window. In some aspects, N may be based at least in part on the implementation of the UE 705. In some aspects, Nₘₐₓ may be configured in the UE 705. In some aspects, N may be based at least in part on a PDB, a resource pool bandwidth, or a quantity of sub-channels. For example, N may increase (or decrease) linearly with the PDB, the resource pool bandwidth, or the quantity of subchannels. Additionally or alternatively, N may inversely increase (or decrease) linearly with the quantity of requested sub-channels. In some other aspects, N may be based at least in part on a packet reliability requirement. For example, N may increase with the packet reliability requirement. In some aspects, N may be decreased based at least in part on the UE 705 selecting a low MCS or coding rate. In some aspects, N may be increased based at least in part on a large PDB or based at least in part on a quantity of available resources in a current resource pool being sufficient.

In some aspects, when the resource skipping is enabled, the quantity of candidate resources N may be adaptively selected. In some aspects, N may be determined for both periodic transmissions and for resource reselection in SPS reservations. In some aspects, after a failed transmission, the UE 705 may select a first value of N for a retransmission. After each packet or TB transmission, N may be increased or decreased by an amount (for example, a configured amount). For SPS communications, the adaptive N may be determined at a time when the UE 705 performs a resource reselection. In an example, the UE 705 may select a value of four (N=4) during a resource selection for SPS. However, the UE 705 may select six (N=6) resources for the resource selection when resource skipping is enabled to allow for sufficient retransmission resources.

In some aspects, in a third operation 725, the UE 705 may perform an initial transmission in the second SPS period using a second resource of the plurality of resources in the second SPS period. For example, in the second SPS period, the UE 705 may skip the first reserved resource (as described above) and may perform an initial transmission in the second SPS period using a second reserved resource. Similarly, for one or more other SPS periods (for example, all SPS periods after the first SPS period), the UE 705 may skip the first resource and may perform the initial transmission in the second resource of the SPS period. Additional details regarding this feature are described in connection with FIG. 8.

As described above, a resource collision in SPS may be more likely to occur in a first resource of the SPS period than in another resource of the SPS period. For example, the UE 710 may be more likely to detect the reservation in the other resource (for example, the second resource or the third resource) than in the first resource of the SPS period. Using the techniques and apparatuses described herein, the UE 705 may be configured to skip a first resource in the SPS period and may perform an initial transmission in the SPS period using a second resources in the SPS period. Thus, the chances of a resource collision in the SPS period may be reduced, resulting in fewer missed communications and fewer required retransmissions.

As indicated above, FIG. 7 is provided as an example. Other examples may differ from what is described with respect to FIG. 7.

FIG. 8 is a diagram illustrating an example 800 of resource skipping, in accordance with the present disclosure.

As described herein, the UE 705 may be configured to perform resource skipping. In some aspects, the UE 705 may perform an initial transmission using a first resource of a first SPS period, such as the resource in the slot m1 of the first SPS period 805. The initial transmission may include a packet. In some aspects, the initial transmission may reserve one or more other resources in the first SPS period 805. Additionally or alternatively, the initial transmission may reserve one or more resources in one or more other SPS periods, such as in the second SPS period 810 and the third SPS period 815. The one or more other resources in the first SPS period 805, the second SPS period 810, and the third SPS period 815 may be used for packet retransmission or HARQ feedback.

In some aspects, the initial transmission in the slot m1 may reserve a second resource of the first SPS period 805 (in the slot m2) and a third resource of the first SPS period 805 (in the slot m3). In some aspects, the initial transmission in the slot m1 may reserve a first resource of the second SPS period 810 (in the slot m1+P), a second resource of the second SPS period 810 (in the slot m2+P), and a third resource of the second SPS period 810 (in the slot m3+P). In some aspects, the initial transmission in the slot m1 may reserve a first resource of the third SPS period 815 (in the slot m1+2P), a second resource of the third SPS period 815 (in the slot m2+2P), and a third resource of the third SPS period 815 (in the slot m3+2P).

As described above, a resource collision in SPS may be more likely to occur in a first resource of the SPS period than in another resource of the SPS period. Thus, the UE 705 may be configured to skip a transmission in the first resource of an SPS period, and to perform an initial transmission of the SPS period in a second resource of the SPS period. For example, the UE 705 may skip the transmission in the first resource of the second SPS period 810 (the resource in the slot M1+P). Instead, the UE 705 may perform an initial transmission in the second SPS period 810 using the second resource of the second SPS period 810 (the resource in the slot M2+P). Similarly, the UE 705 may skip the transmission in the first resource of the third SPS period 815 (the resource in the slot M1+2P). Instead, the UE 705 may perform an initial transmission in the third SPS period 815 using the second resource of the third SPS period 815 (the resource in the slot M2+2P).

As indicated above, FIG. 8 is provided as an example. Other examples may differ from what is described with respect to FIG. 8.

FIG. 9 is a diagram illustrating an example 900 of additional resource reservation, in accordance with the present disclosure.

In some aspects, when the resource skipping is enabled, the UE 705 may reserve one or more additional resources in one or more of the plurality of SPS periods. For example, the UE 705 may reserve one or more additional resources in the plurality of SPS periods after the first SPS period. Thus, the one or more additional resources may be reserved in the second SPS period, or in the second SPS period and all subsequent SPS periods, in accordance with the SPS configuration. The additional resources may be reserved to further avoid resource collision.

In some aspects, when the resource skipping is enabled, the UE 705 may reserve the one or more resources in an early stage of a resource selection window. As shown in the example 900, the resource selection in the first resource selection window 905 may occur within a portion of the resource selection window 905, such as within the first 100 ms of the resource selection window 905. In contrast, the resource selection in the second resource selection window 910 may occur within another portion (for example, a smaller portion) of the second resource selection window 910, such as within the first 50 ms of the second resource selection window 910. In some aspects, reserving the one or more resources in the early stage of the resource selection window may reduce packet latency (for example, transmission or reception latency).

As indicated above, FIG. 9 is provided as an example. Other examples may differ from what is described with respect to FIG. 9.

FIG. 10 is a flowchart illustrating an example process 1000 performed, for example, by a UE in accordance with the present disclosure. Example process 1000 is an example where the UE (for example, UE 120) performs operations associated with sidelink interference reduction.

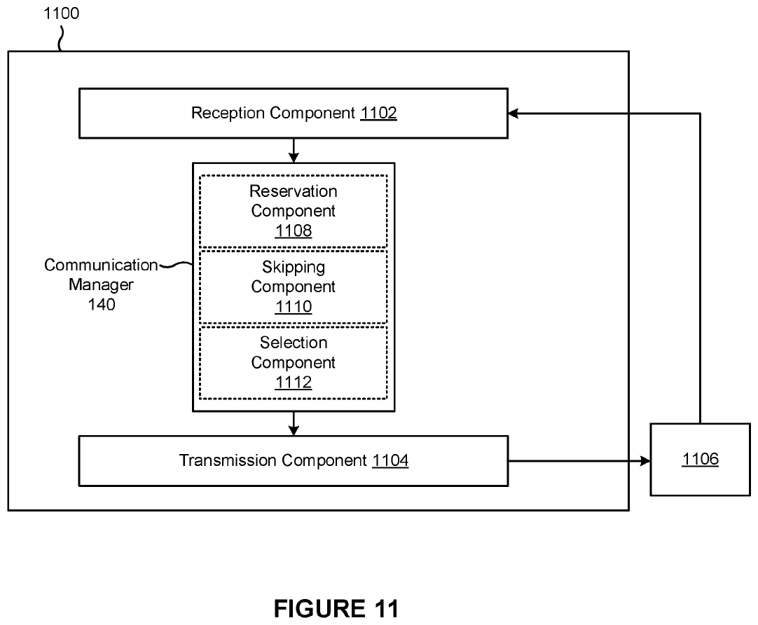

As shown in FIG. 10, in some aspects, process 1000 may include reserving, during a first SPS period of a plurality of SPS periods, a plurality of resources in the plurality of SPS periods (block 1010). For example, the UE (such as by using communication manager 140 or reservation component 1108, depicted in FIG. 11) may reserve, during a first SPS period of a plurality of SPS periods, a plurality of resources in the plurality of SPS periods, as described above.

As further shown in FIG. 10, in some aspects, process 1000 may include skipping a first resource of the plurality of resources in a second SPS period of the plurality of SPS periods (block 1020). For example, the UE (such as by using communication manager 140 or skipping component 1110, depicted in FIG. 11) may skip a first resource of the plurality of resources in a second SPS period of the plurality of SPS periods, as described above.

As further shown in FIG. 10, in some aspects, process 1000 may include performing an initial transmission in the second SPS period using a second resource of the plurality of resources in the second SPS period (block 1030). For example, the UE (such as by using communication manager 140 or transmission component 1104, depicted in FIG. 11) may perform an initial transmission in the second SPS period using a second resource of the plurality of resources in the second SPS period, as described above.

Process 1000 may include additional aspects, such as any single aspect or any combination of aspects described below or in connection with one or more other processes described elsewhere herein.

In a first additional aspect, process 1000 includes skipping a first resource of the plurality of resources in one or more other SPS periods of the plurality of SPS periods.

In a second additional aspect, alone or in combination with the first aspect, process 1000 includes performing an initial transmission in a third SPS period of the plurality of SPS periods using a first resource of the plurality of resources in the third SPS period.

In a third additional aspect, alone or in combination with one or more of the first and second aspects, skipping the first resource in the second SPS period comprises skipping the first resource in the second SPS period based at least in part on a condition.

In a fourth additional aspect, alone or in combination with one or more of the first through third aspects, the condition is a priority threshold.

In a fifth additional aspect, alone or in combination with one or more of the first through fourth aspects, skipping the first resource in the second SPS period based at least in part on the condition comprises skipping the first resource in the second SPS period based at least in part on a packet priority associated with the initial transmission being greater than the priority threshold.

In a sixth additional aspect, alone or in combination with one or more of the first through fifth aspects, the condition is a detection of a resource collision.

In a seventh additional aspect, alone or in combination with one or more of the first through sixth aspects, skipping the first resource in the second SPS period based at least in part on the condition comprises skipping the first resource in the second SPS period based at least in part on receiving an indication from another UE that the resource collision has been detected.

In an eighth additional aspect, alone or in combination with one or more of the first through seventh aspects, skipping the first resource in the second SPS period based at least in part on the condition comprises skipping the first resource in the second SPS period based at least in part on detecting the resource collision from a quantity of consecutive decoding failures.

In a ninth additional aspect, alone or in combination with one or more of the first through eighth aspects, process 1000 includes selecting, during the second SPS period, one or more additional resources in the plurality of SPS periods.

In a tenth additional aspect, alone or in combination with one or more of the first through ninth aspects, selecting the one or more additional resources comprises selecting one or more additional resources that are located in an early stage of a resource selection window of an SPS period of the plurality of SPS periods.

In an eleventh additional aspect, alone or in combination with one or more of the first through tenth aspects, reserving the plurality of resources comprises selecting, during the first SPS period, a plurality of candidate resources in a resource selection window for the initial transmission and one or more potential HARQ retransmissions.

In a twelfth additional aspect, alone or in combination with one or more of the first through eleventh aspects, selecting the plurality of candidate resources comprises selecting the plurality of candidate resources based at least in part on a maximum quantity of possible candidate resources.

In a thirteenth additional aspect, alone or in combination with one or more of the first through twelfth aspects, selecting the plurality of candidate resources comprises selecting the plurality of candidate resources based at least in part on a packet delay budget, a resource pool bandwidth, a quantity of subchannels, or a packet reliability requirement.

In a fourteenth additional aspect, alone or in combination with one or more of the first through thirteenth aspects, selecting the plurality of candidate resources comprises selecting a quantity of candidate resources in an SPS period of the plurality of SPS periods and selecting another quantity of candidate resources in another SPS period of the plurality of SPS periods.

In a fifteenth additional aspect, alone or in combination with one or more of the first through fourteenth aspects, selecting the other quantity of candidate resources comprises selecting the other quantity of candidate resources based at least in part on whether a packet transmission is a successful packet transmission or a failed packet transmission.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a diagram of an example apparatus 1100 for wireless communication in accordance with the present disclosure. The apparatus 1100 may be a UE, or a UE may include the apparatus 1100. In some aspects, the apparatus 1100 includes a reception component 1102, a transmission component 1104, and a communication manager 140, which may be in communication with one another (for example, via one or more buses). As shown, the apparatus 1100 may communicate with another apparatus 1106 (such as a UE, a base station, or another wireless communication device) using the reception component 1102 and the transmission component 1104.

In some aspects, the apparatus 1100 may be configured to perform one or more operations described herein in connection with FIGS. 7-9. Additionally or alternatively, the apparatus 1100 may be configured to perform one or more processes described herein, such as process 1000 of FIG. 10, or a combination thereof. In some aspects, the apparatus 1100 may include one or more components of the UE described above in connection with FIG. 2.

The reception component 1102 may receive communications, such as reference signals, control information, data communications, or a combination thereof, from the apparatus 1106. The reception component 1102 may provide received communications to one or more other components of the apparatus 1100, such as the communication manager 140. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1102 may include one or more antennas, a modem, a demodulator, a MIMO detector, a receive processor, a controller/processor, a memory, or a combination thereof, of the UE described above in connection with FIG. 2.

The transmission component 1104 may transmit communications, such as reference signals, control information, data communications, or a combination thereof, to the apparatus 1106. In some aspects, the communication manager 140 may generate communications and may transmit the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described above in connection with FIG. 2. In some aspects, the transmission component 1104 may be co-located with the reception component 1102 in a transceiver.

The communication manager 140 may reserve, during a first SPS period of a plurality of SPS periods, a plurality of resources in the plurality of SPS periods. The communication manager 140 may skip a first resource of the plurality of resources in a second SPS period of the plurality of SPS periods. The communication manager 140 may perform an initial transmission in the second SPS period using a second resource of the plurality of resources in the second SPS period. In some aspects, the communication manager 140 may perform one or more operations described elsewhere herein as being performed by one or more components of the communication manager 140.

The communication manager 140 may include a controller/processor, a memory, or a combination thereof, of the UE described above in connection with FIG. 2. In some aspects, the communication manager 140 includes a set of components, such as a reservation component 1108, a skipping component 1110, a selection component 1112, or a combination thereof. Alternatively, the set of components may be separate and distinct from the communication manager 140. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reservation component 1108 may reserve, during a first SPS period of a plurality of SPS periods, a plurality of resources in the plurality of SPS periods. The skipping component 1110 may skip a first resource of the plurality of resources in a second SPS period of the plurality of SPS periods. The transmission component 1104 may perform an initial transmission in the second SPS period using a second resource of the plurality of resources in the second SPS period.

The skipping component 1110 may skip a first resource of the plurality of resources in one or more other SPS periods of the plurality of SPS periods.

The transmission component 1104 may perform an initial transmission in a third SPS period of the plurality of SPS periods using a first resource of the plurality of resources in the third SPS period.

The selection component 1112 may select, during the second SPS period, one or more additional resources in the plurality of SPS periods.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: reserving, during a first semi-persistent scheduling (SPS) period of a plurality of SPS periods, a plurality of resources in the plurality of SPS periods; skipping a first resource of the plurality of resources in a second SPS period of the plurality of SPS periods; and performing an initial transmission in the second SPS period using a second resource of the plurality of resources in the second SPS period.

Aspect 2: The method of Aspect 1, further comprising skipping a first resource of the plurality of resources in one or more other SPS periods of the plurality of SPS periods.

Aspect 3: The method of any of Aspects 1-2, further comprising performing an initial transmission in a third SPS period of the plurality of SPS periods using a first resource of the plurality of resources in the third SPS period.

Aspect 4: The method of any of Aspects 1-3, wherein skipping the first resource in the second SPS period comprises skipping the first resource in the second SPS period based at least in part on a condition.

Aspect 5: The method of Aspect 4, wherein the condition is a priority threshold.

Aspect 6: The method of Aspect 5, wherein skipping the first resource in the second SPS period based at least in part on the condition comprises skipping the first resource in the second SPS period based at least in part on a packet priority associated with the initial transmission being greater than the priority threshold.

Aspect 7: The method of Aspect 4, wherein the condition is a detection of a resource collision.

Aspect 8: The method of Aspect 7, wherein skipping the first resource in the second SPS period based at least in part on the condition comprises skipping the first resource in the second SPS period based at least in part on receiving an indication from another UE that the resource collision has been detected.

Aspect 9: The method of Aspect 7, wherein skipping the first resource in the second SPS period based at least in part on the condition comprises skipping the first resource in the second SPS period based at least in part on detecting the resource collision from a quantity of consecutive decoding failures.

Aspect 10: The method of any of Aspects 1-9, further comprising selecting, during the second SPS period, one or more additional resources in the plurality of SPS periods.

Aspect 11: The method of Aspect 10, wherein selecting the one or more additional resources comprises selecting one or more additional resources that are located in an early stage of a resource selection window of an SPS period of the plurality of SPS periods.

Aspect 12: The method of any of Aspects 1-11, wherein reserving the plurality of resources comprises selecting, during the first SPS period, a plurality of candidate resources in a resource selection window for the initial transmission and one or more potential hybrid automatic repeat request (HARQ) retransmissions.

Aspect 13: The method of Aspect 12, wherein selecting the plurality of candidate resources comprises selecting the plurality of candidate resources based at least in part on a maximum quantity of possible candidate resources.

Aspect 14: The method of Aspect 12, wherein selecting the plurality of candidate resources comprises selecting the plurality of candidate resources based at least in part on a packet delay budget, a resource pool bandwidth, a quantity of subchannels, or a packet reliability requirement.

Aspect 15: The method of Aspect 12, wherein selecting the plurality of candidate resources comprises selecting a quantity of candidate resources in an SPS period of the plurality of SPS periods and selecting another quantity of candidate resources in another SPS period of the plurality of SPS periods.

Aspect 16: The method of Aspect 15, wherein selecting the other quantity of candidate resources comprises selecting the other quantity of candidate resources based at least in part on whether a packet transmission is a successful packet transmission or a failed packet transmission.

Aspect 17: An apparatus for wireless communication at a device, comprising a processor; memory coupled with the processor; and instructions stored in the memory and executable by the processor to cause the apparatus to perform the method of one or more of Aspects 1-16.

Aspect 18: A device for wireless communication, comprising a memory and one or more processors coupled to the memory, the one or more processors configured to perform the method of one or more of Aspects 1-16.

Aspect 19: An apparatus for wireless communication, comprising at least one means for performing the method of one or more of Aspects 1-16.

Aspect 20: A non-transitory computer-readable medium storing code for wireless communication, the code comprising instructions executable by a processor to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, since those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. An apparatus for wireless communication at a user equipment (UE), comprising:
a memory; and
one or more processors, coupled to the memory, configured to:
reserve, during a first semi-persistent scheduling (SPS) period of a plurality of SPS periods, a plurality of resources in the plurality of SPS periods;
skip a first resource of the plurality of resources in a second SPS period of the plurality of SPS periods; and
perform an initial transmission in the second SPS period using a second resource of the plurality of resources in the second SPS period.

2. The apparatus of claim 1, wherein the one or more processors are further configured to skip a first resource of the plurality of resources in one or more other SPS periods of the plurality of SPS periods.

3. The apparatus of claim 1, wherein the one or more processors are further configured to perform an initial transmission in a third SPS period of the plurality of SPS periods using a first resource of the plurality of resources in the third SPS period.

4. The apparatus of claim 1, wherein the one or more processors, to skip the first resource in the second SPS period, are configured to skip the first resource in the second SPS period based at least in part on a condition.

5. The apparatus of claim 4, wherein the condition is a priority threshold.

6. The apparatus of claim 5, wherein the one or more processors, to skip the first resource in the second SPS period based at least in part on the condition, are configured to skip the first resource in the second SPS period based at least in part on a packet priority associated with the initial transmission being greater than the priority threshold.

7. The apparatus of claim 4, wherein the condition is a detection of a resource collision.

8. The apparatus of claim 7, wherein the one or more processors, to skip the first resource in the second SPS period based at least in part on the condition, are configured to skip the first resource in the second SPS period based at least in part on receiving an indication from another UE that the resource collision has been detected.

9. The apparatus of claim 7, wherein the one or more processors, to skip the first resource in the second SPS period based at least in part on the condition, are configured to skip the first resource in the second SPS period based at least in part on detecting the resource collision from a quantity of consecutive decoding failures.

10. The apparatus of claim 1, wherein the one or more processors are further configured to select, during the second SPS period, one or more additional resources in the plurality of SPS periods.

11. The apparatus of claim 10, wherein the one or more processors, to select the one or more additional resources, are configured to select one or more additional resources that are located in an early stage of a resource selection window of an SPS period of the plurality of SPS periods.

12. The apparatus of claim 1, wherein the one or more processors, to reserve the plurality of resources, are configured to select, during the first SPS period, a plurality of candidate resources in a resource selection window for the initial transmission and one or more potential hybrid automatic repeat request (HARQ) retransmissions.

13. The apparatus of claim 12, wherein the one or more processors, to select the plurality of candidate resources, are configured to select the plurality of candidate resources based at least in part on a maximum quantity of possible candidate resources.

14. The apparatus of claim 12, wherein the one or more processors, to select the plurality of candidate resources, are configured to select the plurality of candidate resources based at least in part on a packet delay budget, a resource pool bandwidth, a quantity of subchannels, or a packet reliability requirement.

15. The apparatus of claim 12, wherein the one or more processors, to select the plurality of candidate resources, are configured to select a quantity of candidate resources in an SPS period of the plurality of SPS periods and select another quantity of candidate resources in another SPS period of the plurality of SPS periods.

16. The apparatus of claim 15, wherein the one or more processors, to select the other quantity of candidate resources, are configured to select the other quantity of candidate resources based at least in part on whether a packet transmission is a successful packet transmission or a failed packet transmission.

17. A method of wireless communication performed by a user equipment (UE), comprising:
reserving, during a first semi-persistent scheduling (SPS) period of a plurality of SPS periods, a plurality of resources in the plurality of SPS periods;
skipping a first resource of the plurality of resources in a second SPS period of the plurality of SPS periods; and
performing an initial transmission in the second SPS period using a second resource of the plurality of resources in the second SPS period.

18. The method of claim 17, further comprising skipping a first resource of the plurality of resources in one or more other SPS periods of the plurality of SPS periods.

19. The method of claim 17, further comprising performing an initial transmission in a third SPS period of the plurality of SPS periods using a first resource of the plurality of resources in the third SPS period.

20. The method of claim 17, wherein skipping the first resource in the second SPS period comprises skipping the first resource in the second SPS period based at least in part on a condition.

21. The method of claim 20, wherein the condition is a priority threshold.

22. The method of claim 21, wherein skipping the first resource in the second SPS period based at least in part on the condition comprises skipping the first resource in the second SPS period based at least in part on a packet priority associated with the initial transmission being greater than the priority threshold.

23. The method of claim 20, wherein the condition is a detection of a resource collision.

24. The method of claim 23, wherein skipping the first resource in the second SPS period based at least in part on the condition comprises skipping the first resource in the second SPS period based at least in part on receiving an indication from another UE that the resource collision has been detected.

25. The method of claim 23, wherein skipping the first resource in the second SPS period based at least in part on the condition comprises skipping the first resource in the second SPS period based at least in part on detecting the resource collision from a quantity of consecutive decoding failures.

26. The method of claim 17, further comprising selecting, during the second SPS period, one or more additional resources in the plurality of SPS periods.

27. The method of claim 26, wherein selecting the one or more additional resources comprises selecting one or more additional resources that are located in an early stage of a resource selection window of an SPS period of the plurality of SPS periods.

28. The method of claim 17, wherein reserving the plurality of resources comprises selecting, during the first SPS period, a plurality of candidate resources in a resource selection window for the initial transmission and one or more potential hybrid automatic repeat request (HARQ) retransmissions.

29. The method of claim 28, wherein selecting the plurality of candidate resources comprises selecting the plurality of candidate resources based at least in part on a maximum quantity of possible candidate resources.

30. A non-transitory computer-readable medium storing a set of instructions for wireless communication, the set of instructions comprising:
one or more instructions that, when executed by one or more processors of a user equipment (UE), cause the UE to:
reserve, during a first semi-persistent scheduling (SPS) period of a plurality of SPS periods, a plurality of resources in the plurality of SPS periods;
skip a first resource of the plurality of resources in a second SPS period of the plurality of SPS periods; and
perform an initial transmission in the second SPS period using a second resource of the plurality of resources in the second SPS period.

31. The non-transitory computer-readable medium of claim 30, wherein the one or more instructions further cause the UE to skip a first resource of the plurality of resources in one or more other SPS periods of the plurality of SPS periods.

32. The non-transitory computer-readable medium of claim 30, wherein the one or more instructions further cause the UE to perform an initial transmission in a third SPS period of the plurality of SPS periods using a first resource of the plurality of resources in the third SPS period.

33. An apparatus for wireless communication, comprising:
means for reserving, during a first semi-persistent scheduling (SPS) period of a plurality of SPS periods, a plurality of resources in the plurality of SPS periods;
means for skipping a first resource of the plurality of resources in a second SPS period of the plurality of SPS periods; and
means for performing an initial transmission in the second SPS period using a second resource of the plurality of resources in the second SPS period.

34. The apparatus of claim 33, further comprising means for skipping a first resource of the plurality of resources in one or more other SPS periods of the plurality of SPS periods.

35. The apparatus of claim 33, further comprising means for performing an initial transmission in a third SPS period of the plurality of SPS periods using a first resource of the plurality of resources in the third SPS period.
